(19) United States
(12) Patent Application Publication
(10) Pub. No.: US 2005/0010679 A1
(43) Pub. Date: Jan. 13, 2005

(54) Method and system for optimizing sending and reception of message

(75) Inventors: Hiroyuki Yamaga, Minato-ku (JP); Mikito Hirata, Minato-ku (JP); Toru Usami, Minato-ku (JP); Tomohiko Asano, Minato-ku (JP); Hiroshi Date, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/845,159

(22) Filed: May 14, 2004

(30) Foreign Application Priority Data
May 15, 2003 (JP) 2003-137282

(51) Int. Cl. G06F 15/16

(52) U.S. Cl. 709/232

(57) ABSTRACT

A message sending and reception optimizing method using a sender's end information processing apparatus disposed on a sender's end of a message and a recipient's end information processing apparatus disposed on a recipient's end of the message has a step of determining an optimum form of message sending and reception while considering convenience of a sender and/or a recipient by communicating predetermined information between the sender's end information processing apparatus and the recipient's end information processing apparatus before performance of the message sending and reception.

### BACKGROUND OF THE INVENTION

1. Field of the Invention

The present invention relates generally to the sending and reception of messages by using a communication system such as a mobile telephone network, the Internet or the like, and more particularly to a method for optimizing a transmission form of message and a system thereof.

2. Description of the Related Art

Various communication systems have been recently advanced, and the necessity of manners and morals of message senders has been socially heightened so as to make the senders deeply grasp circumstances of message recipients and send messages to the recipients in ways most desired by the recipients.

Further, the number of terminals used by each user is showing a tendency to increase, and there are various types of terminals. In this situation, when a terminal of a message sender's end establishes connection to a plurality of terminals of one or more message recipient's ends, the connection of the terminals is often difficult. The reasons are that (1) communication protocols used by the terminals differ from one another and (2) compatibility between terminals of a sender's end and a recipients end is not maintained due to the difference between messaging tools (e.g., mail tools, instant messaging (IM) tools, IP telephones and the like) used in the terminals. In addition, a charge or payment for each service or contents of each provided service changes with a type of a terminal of a recipient's end, and it is difficult that the message sender realizes the charge.

Therefore, in this situation, it is difficult that, each time a sender send a message, the sender selects a transmission form of the message optimum to circumstances of a recipient so that the recipient receives the massage in the most desired form to the recipient. A transmission form of the message includes a type of a terminal of a recipient's end, a type of a messaging tool used in the recipient's end, a communication route of a message, a type of a message and the like.

To solve problems described above, for example, in Japanese Patent Laid-open Application No. H10-336319 (JP, 10-226319, A), a technique is disclosed that information relating to the reception form such as types of communication devices, communication methods, communication routes and the like based on circumstances of recipients is stored in advance in a storage of a communication system, a sender receives the information relating to the reception form of a recipient by gaining access to the storage when the sender intends to send a message to the recipient, and the sender sends a message to the recipient according to the information. In this technique, there is advantage that a recipient can receive a message in an optimum reception form based on circumstances of the recipient.

Further, in Japanese Patent Laid-open Application No. 2002-157196 (JP, P2002-157196A), a technique is disclosed that a sender examines a data type usable in a terminal of a recipients end, convert a message to that of the data type usable in the terminal of the recipient's end and sends the message to the recipient. In this technique, there is advantage that a recipient can receive a message in a data format (or form) usable in his or her terminal.

However, in the technique disclosed in the JP, H10-336319, A, a recipient is required to store the information relating to an optimum reception form based on circumstances of the recipient in the storage of the network in advance. Therefore, when the recipient is in a static receiving state, the message sending and reception can be adequately performed. However, when the recipient is in a dynamic receiving state changing with time, the message transmission cannot be adequately performed. To adequately perform the message transmission when the recipient is in the dynamic receiving state, each time the reception form optimum to the recipient is changed, the recipient is required to store the information relating to the reception form In the storage of the communication system.

Further, in the techniques disclosed in the JP, 10-336319, A and the JP, P2002-157196A, the message sending and reception can be adequately performed regardless of the convenience of the recipient. However, though there is the convenience of a sender that the sender desires to send a message having a specific type of contents in a specific sending form, there is no consideration in the techniques as to the convenience of the sender.

The above and other objects, features, and advantages of the present invention will become apparent from the following description with reference to the accompanying drawings which illustrate examples of the present invention.

### SUMMARY OF THE INVENTION

A first object of the present invention is to provide a message sending and reception optimizing method in which a transmission form of message is optimized for both a sender and a recipient.

A second object of the present invention is to provide a message sending and reception optimizing system in which a transmission form of message is optimized for both a sender and a recipient.

The first object of the present invention is achieved by the provision of a method for optimizing sending and reception of a message between a sender's end information processing apparatus disposed on a sender's end of a message and a recipient's end information processing apparatus disposed on a recipient's end of the message, the method comprising the step of determining an optimum transmission form of the message while considering convenience of a sender and/or a recipient by communicating predetermined information between the sender's end information processing apparatus and the recipient's end information processing apparatus before the performance of the message sending and reception.

The second object of the present invention is achieved by the provision of a system for optimizing sending and reception of a message, the system comprising a sender's end information processing apparatus disposed on a sender's end of a message, and a recipient's end information processing apparatus disposed on a recipient's end of the message and connected with the sender's end information processing apparatus through a network. The sender's end information processing apparatus has a sender's end judgment system, the recipient's end information processing apparatus has a recipient's end judgment system, and the sender's end judgment system and the recipient's end judgment system determine, before performing the message sending and reception, an optimum transmission form of the message while considering the convenience of a sender and/or a recipient by communicating predetermined information with each other.

In the present invention, before performing the message sending and reception between the sender's end information processing apparatus and the recipient's end information processing apparatus, an optimum transmission form of the message is determined while considering the convenience of the sender and/or the recipient by communicating predetermined information. Therefore, not only the transmission form of the message can be optimized for both the sender and the recipient, but also the transmission can be optimized for either the sender or the recipient.

More particularly, contents of the message are analyzed in the sender's end information processing apparatus before the sending of the message. Then, in the recipient's end information processing apparatus, one or more candidates for a destination (the destination denotes where a message is to be sent) are selected according to an analyzed result of the message and recipient's end presence information. One or more optimum destinations selected from the candidate for the destination are determined in the sender's end information processing apparatus.

Accordingly, because one or more candidates for a destination of the message are selected by the recipient according to the analyzed result of the contents of the message prepared by the sender, the convenience of the sender is considered for the sender when a transmission form of the message is determined. In construct, because the candidates for the destination of the message are selected according to the recipient's end presence information indicating that where the recipient stays, what the recipient does, what terminal(s) the recipient uses and from who the recipient desires to receive a message, the convenience of the recipient is considered for the recipient when the transmission form of the message is determined.

Further, when the candidate for the destination is selected, the recipient's end information processing apparatus is configured to select the candidate for the destination by considering both the recipient and the sender or by giving priority to either the recipient or the sender. When one or more optimum destinations are selected from the candidates for the destination of the message, the sender's end information processing apparatus is configured to determine the optimum destinations by considering both the recipient and the sender or by giving priority to either the recipient or the sender. Therefore, the entire convenience of both the recipient and the sender can be further pursued.

Accordingly, the present invention can be applied for the usage corresponding to various circumstances such as the consideration for a business message in a private time period of a recipient, the prevention of reception of attached data impossible to be referred at a recipient terminal, and the performance of sending and reception of the message so as to lower cost of the communication for the sender's end and/or the recipient's end.

### BRIEF DESCRIPTION OF THE DRAWINGS

FIG. 1 is a block diagram showing a message sending and reception optimizing system according to an embodiment of the present invention;

FIG. 2 is a flow chart briefly describing an operation of the system shown in FIG. 1 when a sender and a recipient communicate with each other in one-to-one correspondence;

FIG. 3A is a flow chart describing in detail an operation of the system shown in FIG. 1 when a sender and a recipient communicate with each other in one-to-one correspondence;

FIG. 3B is a flow chart describing in detail an operation of the system shown in FIG. 1 following the operation illustrated in FIG. 3A when a sender and a recipient communicate with each other in one-to-one correspondence; and

FIG. 4 is a flow chart briefly describing an operation of the system shown in FIG. 1 when a sender and a plurality of recipients communicate with each other in one-to-N correspondence where N Is an integer greater than 1.

### DETAILED DESCRIPTION OF THE PREFERRED EMBODIMENTS

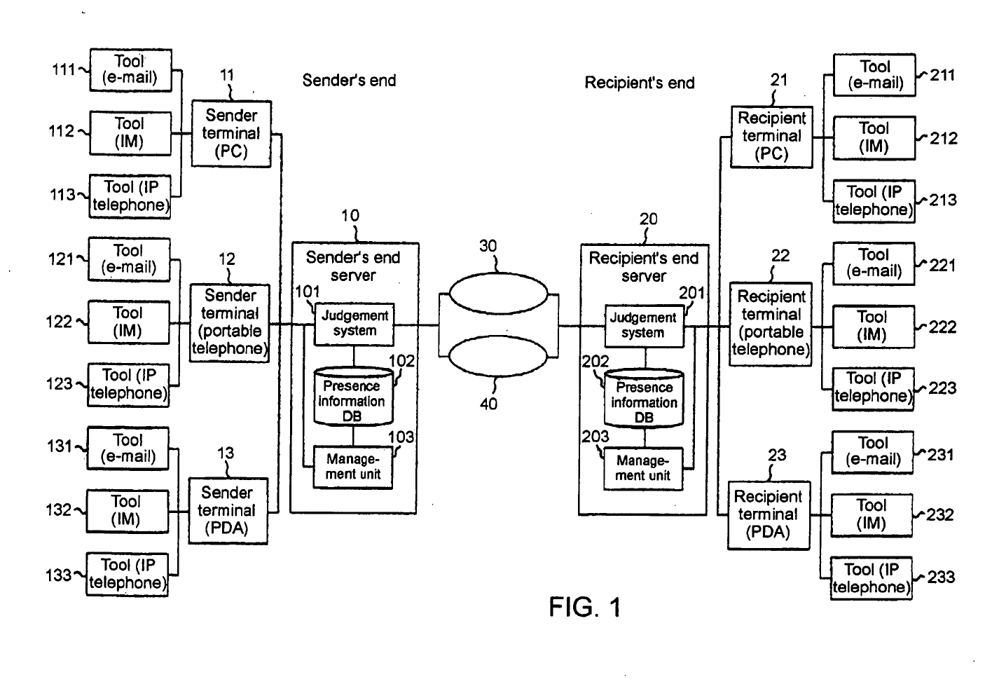

A message sending and reception optimizing system shown in FIG. 1 according to a preferred embodiment of the present invention comprises sender's end server 10 disposed on a sender's end of a message, and recipient's end server 20 disposed on a recipient's end of the message. Sender's end server 10 and recipient's end server 20 are configured so as to enable them to be connected with each other through each of two communication routes of portable telephone network 30 and Internet 40. Each of sender's end server 10 and recipient's end server 20 can be realized by a general information processing apparatus such as a computer for server, a personal computer (PC), a work station (WS), a supercomputer or the like.

Sender's end server 10 is connected with sender terminals 11, 12 and 13 such as PC, a portable telephone, a personal digital assistant (PDA) and the like used by the sender denoting a user. These sender terminals 11 to 13 are provided with messaging tools 111, 112, 113, 121, 122, 123, 131, 132 and 133 denoting tools of applications such as electronic mail (e-mail), instant messaging (IM), IP telephone and the like. Each sender terminal may be provided with a function of measuring its position by using a global positioning system (GPS).

Recipient's end server 20 is connected with recipient terminals 21, 22 and 23 such as PC, a portable telephone, PDA and the like used by the recipient denoting a user. These recipient terminals 21, 22 and 23 are provided with messaging tools 211, 212, 213, 221, 222, 223, 231, 232 and 233 denoting tools of applications such as e-mail, IM, IP telephone and the like. Each recipient terminal may be provided with a function of measuring its position by using GPS.

A constitutional example of the terminals and the messaging tools used by each of the sender and the recipient is shown in Table 1.

TABLE 1

| | | Recipient's end | |
|---|---|---|---|
| Sender's end | | Recipient | |
| Sender terminal | Messaging tool | terminal | Messaging tool |
| PC (11) | e-mail (111) | PC(21) | e-mail (211) |
| | IM (112) | | IM (212) |
| | IP telephone (113) | | IP telephone (213) |
| Portable | e-mail (121) | Portable | e-mail (221) |
| telephone (12) | IM (122) | telephone | IM (222) |
| | IP telephone (123) | (22) | IP telephone (223) |
| PDA (13) | e-mail (131) | PDA (23) | e-mail (231) |
| | IM (132) | | IM (232) |
| | IP telephone (133) | | IP telephone (233) |

Sender's end server 10 has judgment system 101, presence information DB (data base) 102 and presence information management unit 103. Recipient's end server 20 has judgment system 201, presence information DB 202 and presence information management unit 203.

Presence information management unit 103 of the sender's end manages sender's end presence information by storing the presence information as a data base in presence information DB 102. The sender's end information denotes information relating to total conditions of the sender or the sender terminals used by the sender. More particularly, the sender's end presence information includes information of a schedule of the sender, information of the sender terminals used by the sender, information of the messaging tools in each sender terminal used by the sender, positional information indicating a current position of each sender terminal, information of tendency of use of each sender terminal, information (for example, size or the like) of a display panel of each sender terminal, information of an address book of each sender terminal, information of each communication route through which a message is sent, and the like. Presence Information management unit 103 manages a current position of each sender terminal according to GPS information or the like obtained in the sender terminal. Further, presence information management unit 103 periodically reads the sender's end presence information or reads the presence information each time the presence information changes, and the presence information in presence information DB 102 is renewed to updated information.

In contrast, presence information management unit 203 of the recipient's end manages recipient's end presence information by storing the presence information as a data base in presence information DB 202. The recipient's end presence information denotes information relating to total conditions of the recipient or the recipient terminals used by the recipient. More particularly, the recipient's end presence information includes information of a schedule of the recipient, information of the recipient terminals used by the recipient, information of the messaging tools in each recipient terminal used by the recipient, positional information indicating a current position of each recipient terminal, information of tendency of use of each recipient terminal, information (for example, size or the like) of a display panel of each recipient terminal, information of an address book of each recipient terminal, information of each communication route through which a message is received, and the like. Presence information management unit 203 manages a current position of each recipient terminal according to GPS information or the like obtained in the recipient terminal. Further, presence information management unit 203 periodically reads the recipient's end presence information or reads the presence information each time the information changes, and the presence information in presence information DB 202 is renewed to updated information.

Table 2 shows an example of the recipient's end presence information managed by storing the presence information as a data base in presence information DB 202.

TABLE 2

| User | | | | | | Use tendency | |
|---|---|---|---|---|---|---|---|
| name | Terminal | Tool | Status | Address | Place | of tool | ... |
| Mr. B | PC (21) | e-mail (211) | ON | xxx@yyy | Office | 09:00 to 18:30 | ... |
| | | IM (212) | ON | xxy@yyz | | 09:00 to 18:30 | ... |
| | | IP telephone | OFF | 050abcde | | 11:00 to 14:00 | ... |
| | | (213) | | | | | |
| | Portable | e-mail (221) | ON | aaa@bbb | Office | 19:00 to 23:00 | ... |
| | telephone | IM (222) | OFF | ccc@ddd | | 21:00 to 23:00 | ... |
| | (22) | IP telephone | OFF | 050bcdef | | 19:00 to 23:00 | ... |
| | | (223) | | | | | |
| | PDA (23) | e-mail (231) | OFF | eee@fff | Office | 11:00 to 15:00 | ... |
| | | IM (232) | OFF | ggg@hhh | | 12:00 to 16:00 | ... |
| | | IP telephone | OFF | 050cdefg | | 12:00 to 16:00 | ... |
| | | (233) | | | | | |

Judgment system 101 of the sender's end and judgment system 201 of the recipient's end determine, before the sending and reception of a message, an optimum transmission form of the message while considering the convenience of the sender and/or the recipient by communicating predetermined information to each other. The transmission form of a message is a form or manner of massage in which a message is sent and received.

More particularly, judgment system 101 of the sender's end is provided with a function of analyzing contents of a message prepared in one of sender terminals 11 to 13 and sending the analyzed result to judgment system 201 of the recipient's end, a function of determining an optimum place or item where the message is to be sent (hereinafter, “place or item where a message is to be sent” is abbreviated to “destination”) according to a list of candidate for destination (hereinafter, named destination candidate list) sent from judgment system 201 of the recipient's end and the sender's end presence information stored in presence information DB 102, and a function of converting a form of a message to one corresponding to a tool of a terminal (hereinafter, “tool of terminal” is abbreviated to “terminal tool”) of a destination and/or an analyzed result of the message and then sending the converted message to the terminal tool of the destination.

In contrast, judgment system 201 of the recipient's end is provided with a function of preparing the destination candidate list according to the analyzed result of the message and the sender's end presence information stored in presence information DB 202, and sending the destination candidate list to Judgment system 101 of the sender's end. Here, the analyzed result of the message has been sent from judgment system 101 of the sender's end

In this embodiment, disposed positions or locations of sender's end server 10 and recipient's end server 20 are not limited. For example, the server 10 or 20 may be disposed in a house of the sender or the recipient as a home server or may be disposed in a place other than the house as a server of a network service provider's end.

Hereinafter, an operation of the message sending and reception optimizing system shown in FIG. 1 according to this embodiment will be described.

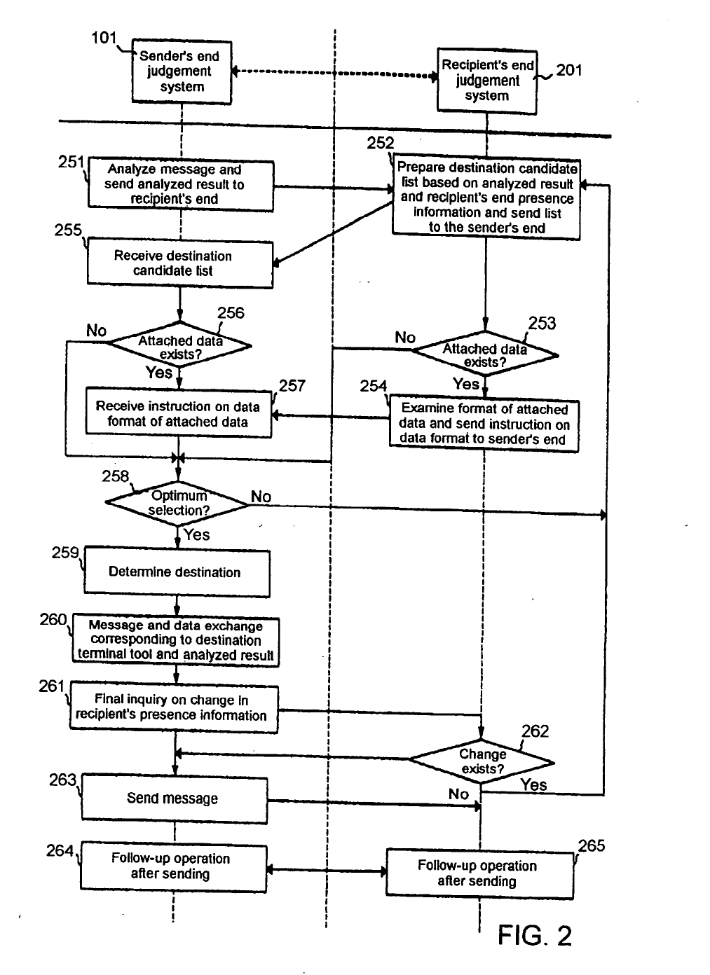

First, the operation of the system shown In FIG. 1 according to this embodiment will be briefly described with reference to FIG. 2. In FIG. 2, a sender and a recipient communicate with each other in one-to-one correspondence.

At step 251, judgment system 101 of the sender's end initially analyzes contents of a message prepared by the sender in one of sender terminals 11 to 13 and sends an analyzed result of the message to judgment system 201 of the recipient's end. In this case, when attached data is attached to the message, an analyzed result of the attached data is included in the analyzed result of the message.

At step 252, judgment system 201 of the recipient's end prepares a list of one or more candidates for a destination (i.e. terminal tool of the recipient) suitable to the analyzed result of the message according to the analyzed result of the message and the recipient's end present information. The analyzed result of the message has been sent from judgment system 101 of the sender's end and the recipient's end presence information is stored in the presence information DB 202. Judgment system 201 then sends the prepared destination candidate list to judgment system 101 of the sender's end. In this case, judgment system 201 of the recipient's end may select the candidate for the destination by giving priority to the convenience of the recipient or may select the candidate for the destination while considering the convenience of both the recipient and the sender. Or judgment system 201 of the recipient's end may select the candidate for the destination by giving priority to the convenience of the sender. Further, when one or more terminal tools of the recipient already set in an on-state exist in the tools of the recipient terminals 21 to 23, judgment system 201 selects the candidate for the destination from the terminal tools of the recipient already set in the on-state. When no terminal tool of the recipient already set in the on-state exists, judgment system 201 selects one or more terminal tools of the recipient predicted to be earliest set to the on-state at high possibility as the candidate for the destination according to tendency information of the messaging tools used at past time, schedule information of the recipient and the like.

Thereafter, at step 253, judgment system 201 of the recipient's end judges whether or not attached data is attached to the message. When no attached data is attached, the control proceeds to step 258. When attached data is attached, judgment system 201 examines, at step 254, a data format (or form) of the attached data in the sending of the attached data according to information of a storage capacity of each candidate for the destination and the like and sends to sender's end judgment system 101 an instruction Indicating a data format of the attached data. As to selection items of the data format in the sending of the attached data, for example, there are an original structure of the attached data in the sending, a compressed structure of the attached data in the sending, a divided structure of the attached data in the sending, a partly-deleted structure of the attached data in the sending, an entirely-deleted structure of the attached data in the sending (that is, no attached data in the sending) and the like.

At step 255, judgment system 101 of the sender's end receives the destination candidate list sent from judgment system 201 of the recipient's end. At step 256, judgment system 101 of the sender's end judges whether or not attached data is attached to the message. When attached data is attached to the message, judgment system 101 receives, at step 257, the instruction of the data format of the attached data sent from judgment system 201 of the recipient's end. When judgment system 101 judges at step 256 that no attached data is attached, the control proceeds to step 258.

At step 258, judgment system 101 of the sender's end judges according to the destination candidate list sent from judgment system 201 of the recipient's end and the sender's end presence Information stored in presence information DB 102 whether or not one or more optimum destination exists in the destination candidate list. When no optimum destination exists or judgment system 101 of the sender's end is not satisfied with the candidate for the destination, the control returns to the process of step 252. In contrast, when one or more optimum destinations exist in the destination candidate list at step 258, judgment system 101 of the sender's end determines, at step 259, one or more terminal tools of the destination candidate list as one or more destinations. A communication route is automatically determined to either portable telephone network 30 or Internet 40 according to the destination determined at step 259. In this case, judgment system 101 of the sender's end may determine the destination by giving priority to the convenience of the sender or may determine the destination while considering the convenience of both the sender and the recipient. Or the destination may be determined by giving priority to the convenience of the recipient.

When judgment system 101 of the sender's end determines the destination at step 259, judgment system 101 determines, at step 260, a form of the message so as to correspond to the analyzed result of the message analyzed at step 251 and the terminal tool of the recipient determined at step 259 as the destination and converts the form of the message to the determined form. Further, when attached data is attached to the message, judgment system 101 converts the form of the attached data to the data format instructed by judgment system 201 of the recipient's end.

Then, at step 261, judgment system 101 of the sender's end performs a final check of the destination by inquiring of judgment system 201 of the recipient's end whether or not the recipient's end presence information is changed. In response to the final inquiry, judgment system 201 of the recipients end judges at step 262 whether or not the recipient's end presence information is changed. When the recipients end presence information is changed, the control returns to the process of step 252. In contrast, when the recipient's end presence information is not changed, judgment system 101 of the sender's end sends, at step 263, a message to the one or more determined tools of one or more corresponding recipient terminals 21, 22 and/or 23 through judgment system 201 of the recipient's end.

After the sending and reception of the message, judgment system 101 of the sender's end and judgment system 201 of the recipient's end perform follow-up operations based on the result of the message sending and reception at steps 264 and 265 by communicating predetermined information to each other. For example, when one or more different terminal tools of the recipient is/are set to the on-state earlier than the terminal tools of the recipient predicted at step 252 to be earliest set to the on-state, or when one of the terminal tools of the recipient determined at step 259 as the destination receives the message, the follow-up operations are performed.

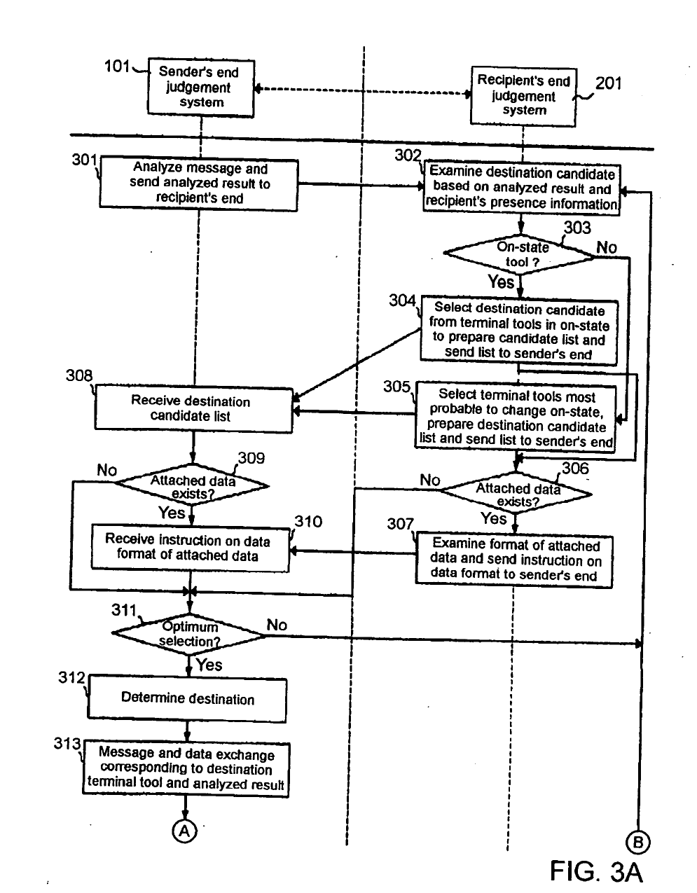

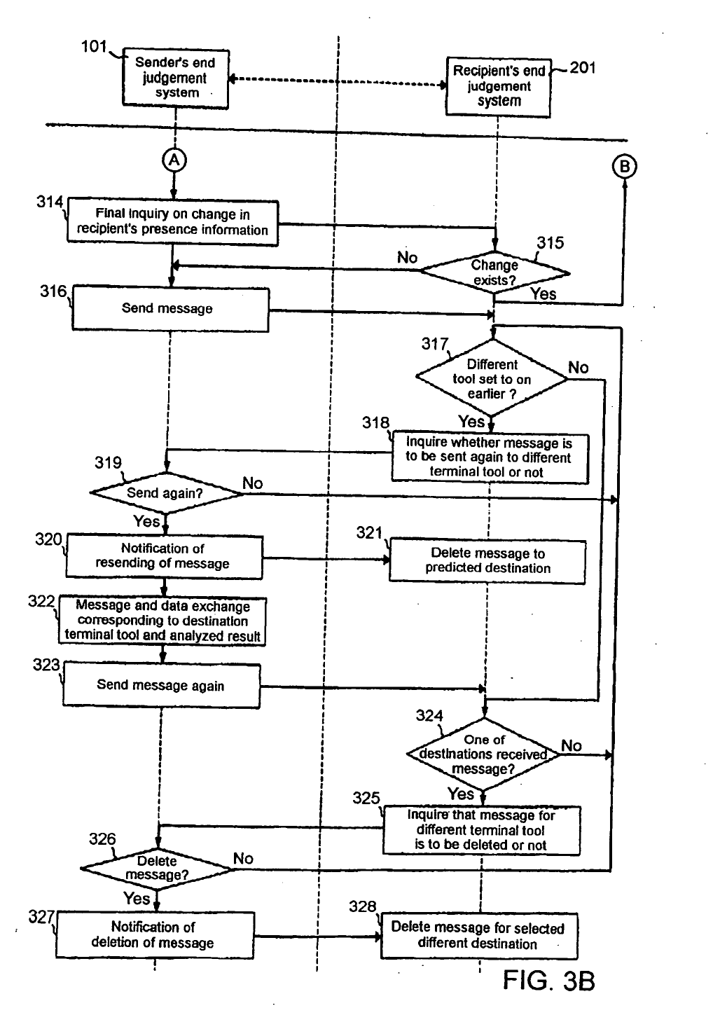

Next, the operation of the system shown in FIG. 1 according to this embodiment will be described in detail with reference to FIGS. 3A and 3B. In FIGS. 3A and 3B, a sender and a recipient communicate with each other in one-to-one correspondence.

Initially, at step 301, judgment system 101 of the sender's end analyzes contents of the message prepared by the sender in one of sender terminals 11 to 13 and sends the analyzed result of the message to judgment system 201 of the recipient's end. For example, when judgment system 101 of the sender's end analyzes the message prepared in one of sender terminals 11 to 13, judgment system 101 checks a plurality of check items of Table 3, judges whether or not the message is urgent, judges whether the message relates to a matter of business or a private affair, and checks the attached data.

TABLE 3

| Check item | Judgment criterion |
|---|---|
| Judgment of | Retrieve keyword used for urgency such as “highly |
| urgency of message | urgent”, “normally urgent”, “urgent” or the like |
| | Retrieve keyword used for plan change such as |
| | “change”, “cancel”, “postpone”, “delay”, “earlier” |
| | or the like |
| Judgment to be | Retrieve keyword used for business such as “Sirs”, |
| business message or | “Mr.”, “Ms.”, “Inc.”, “case” or the like |
| private message | |
| Check of attached | Check existence, size and extension of attached data |
| data | |

At step 302, judgment system 201 of the recipient's end examines one or more candidates for a destination according to the analyzed result of the message sent from judgment system 101 of the sender's end and the recipient's end presence information stored in presence information DB 202. In this case, judgment system 201 of the recipient's end may select the candidate for the destination place by giving priority to the convenience of the recipient or may select the candidate for the destination while considering the convenience of both the recipient and the sender. Or judgment system 201 may select the candidate for the destination by giving priority to the convenience of the sender. For example, judgment system 201 selects one or more candidates for the destination according to the analyzed result of the message indicating that the message is urgent or relates to a matter of business or a private affair, a current time and the judgment that the convenience of both the recipient and the sender is considered or priority is given to the convenience of the sender or the recipient. Table 4 shows an example of how to select the candidates for the destination in each of various circumstances.

TABLE 4

| | | Case of | Case of | Case of |
|---|---|---|---|---|
| | | considering | giving | giving |
| | | convenience of | priority to | priority to |
| | | both sending and | convenience | convenience |
| | | recipients | of sender | of recipient |
| Busi- | Week day | A | A | O |
| ness | 9:00 to 17:00 | | | |
| message | Week day | O | A | O |
| | 17:00 to 24:00 | | | |
| | Week end | O | O | A |
| Urgent | Week day | A | A | O |
| business | 9:00 to 17:00 | | | |
| message | Week day | A | A | A |
| | 17:00 to 24:00 | | | |
| | Week end | O | A | O |
| Private | Week day | P | P | P |
| message | 9:00 to 17:00 | | | |
| | Week day | P | A | P |
| | 17:00 to 24:00 | | | |
| | Week end | A | A | A |
| Urgent | Week day | A | A | A |
| private | 9:00 to 17:00 | | | |
| message | Week day | A | A | A |
| | 17:00 to 24:00 | | | |
| | Week end | A | A | A |

A: Message can be sent to any of all terminal tools.
O: Message can be sent to any of terminal tools in office
P: Message can be sent to any of terminal tools other than those in office

Further, at step 303, judgment system 201 of the recipient's end judges whether or not one or more terminal tools of the recipient set in an on-state exist in each of the recipient terminals 21 to 23. When one or more terminal tools of the recipient already set in the on-state exist, judgment system 201 prepares, at step 304, a destination candidate list by selecting one or more candidates for the destination from the terminal tools of the recipient already set in the on-state and sends the prepared destination candidate list to judgment system 101 of the sender's end. When no terminal tool of the recipient already set in the on-state exists at step 303, judgment system 201 of the recipient's end prepares, at step 305, a destination candidate list by selecting one or more terminal tools of the recipient predicted to be earliest set to the on-state at high possibility as one or more candidates for the destination according to tendency information of messaging tools used at past time, schedule information and the like and sends the prepared destination candidate list to judgment system 101 of the sender's end.

After the process at step 304 or 305 is performed, judgment system 201 of the recipient's end judges at step 306 whether or not attached data is attached to the message. When no attached data is attached to the message, the process proceeds to step 311. In contrast, when attached data is attached to the message, judgment system 201 examines, at step 307, a data format in the sending of the attached data according to information such as information of a storage capacity of each candidate for the destination and sends an instruction of the data format of the attached data to judgment system 101 of the sender's end. In the examination of the data format, a sending form of the attached data is examined and selected from various sending forms such as the sending of the attached data having an original structure, the sending of the attached data having a compressed structure, the sending of the attached data having a divided structure, the sending of the attached data having a partly-deleted structure, the sending of the attached data having an entirely-deleted structure and the like.

Judgment system 101 of the sender's end receives, at step 308, the destination candidate list sent from judgment system 201 of the recipients end and judges at step 309 whether or not attached data is attached to the message. When no attached data is attached to the message, the control proceeds to the process of step 311. When attached data is attached to the message, judgment system 101 of the sender's end receives, at step 310, the instruction of the data format of the attached data sent from judgment system 201 of the recipient's end, and the control proceeds to the process of step 311.

At step 311, according to the destination candidate list sent from judgment system 201 of the recipient's end and the sender's end presence information stored in presence information DB 102, judgment system 101 of the sender's end judges whether or not one or more optimum destinations exist in the destination candidate list. When no optimum sending place exists, or when judgment system 101 is not satisfied with the candidate for the destination, the control returns to the process of step 302. In contrast, when one or more optimum destinations exist in the destination candidate list, judgment system 101 determines, at step 312, one or more terminal tools selected from the destination candidate list as one or more destinations. A communication route is automatically determined to either portable telephone network 30 or Internet 40 according to the destination determined at step 312. In this case, judgment system 101 may determine the destination by giving priority to the convenience of the sender or may determine the destination while considering the convenience of both the sender and the recipient. Or judgment system 101 may determine the destination by giving priority to the convenience of the recipient. For example, priority is given to the sender (or the recipient) when judgment system 101 determines one or more terminal tools of the recipient so as to make costs of sending and reception for the sender (or the recipient) lowest.

When judgment system 101 of the sender's end determines the destination at step 312, judgment system 101 determines, at step 313, a form of the message corresponding to the analyzed result of the contents of the message analyzed at step 301 and the terminal tools of the recipient determined at step 312 as the destinations and converts the form of the message to the determined form. Further, when attached data is attached to the message, judgment system 101 converts the form of the attached data to the data format instructed by judgment system 201 of the recipient's end.

Then, at step 314, judgment system 101 of the sender's end performs a final check of the destination by inquiring of judgment system 201 of the recipient's end whether or not the recipient's end presence information is changed. In response to the final inquiry, judgment system 201 of the recipient's end judges at step 315 whether or not the recipient's end presence information is changed. When the presence information is changed, the control returns to the process of step 302. In contrast, when the recipient's end presence information is not changed, judgment system 101 of the sender's end sends, at step 316, a message to the determined tools of one or more corresponding recipient terminals 21, 22 and/or 23 through judgment system 201 of the recipient's end.

After the sending and reception of the message, judgment system 101 of the sender's end and judgment system 201 of the recipient's end perform follow-up operations based on the result of the message sending and reception by communicating predetermined information to each other.

For example, judgment system 201 of the recipient's end judges at step 317 whether or not one or more different terminal tools of the recipient is/are set to the on-state earlier than the terminal tools of the recipient predicted at step 305 to be earliest set to the on-state. When the predicted terminal tools of the recipient are earliest set to the on-state, the control proceeds to step 324 without performing any process. In contrast, when one or more different terminal tools of the recipient is/are set to the on-state earlier than the predicted ones, judgment system 201 inquires of judgment system 101 of the sender's end at step 318 whether or not judgment system 101 of the sender's end again sends the message to the different terminal tools of the recipient. By receiving this inquiry, judgment system 101 of the sender's end judges at step 319 whether or not judgment system 101 again sends the message. When judgment system 101 determines to again send the message to the different terminal tools of the recipient corresponding to the inquiry of judgment system 201 of the recipient's end, judgment system 101 of the sender's end notifies judgment system 201 of the recipient's end at step 320 that judgment system 101 of the sender's end intends to again send the message to the different terminal tools of the recipient. At step 321, judgment system 201 of the recipient's end receiving the notice deletes the message sent to the terminal tools of the recipient predicted to be earliest set to the on-state. At step 322, judgment system 101 of the sender's end converts the message to a message having a form corresponding to the different terminal tools of the recipient to which the message is planned to be again sent. Further, when attached data is attached to the message, judgment system 101 of the sender's end converts the attached data to attached data having the data format instructed by judgment system 201 of the recipient's end. Thereafter, at step 323, judgment system 101 of the sender's end sends the message to the different terminal tools of the recipient, which is set to the on-state earlier than those predicted to be earliest set to the on-state, through judgment system 201 of the recipient's end. Thereafter, the processing proceeds to step 324.

At step 324, judgment system 201 of the recipient's end judges whether or not one of the plurality of terminal tools of the recipient determined as the destination at step 312 receives the message. When no sending place receives the message, the processing returns to step 317. When one of the terminal tools of the recipient receives the message, Judgment system 201 inquires of judgment system 101 of the sender's end, at step 325, whether or not judgment system 201 of the recipient's end deletes the message sent to the other terminal tools of the recipient.

By receiving the inquiry sent at step 325, judgment system 101 of the sender's end judges at step 326 whether or not the message sent to the other terminal tools of the recipient should be deleted. In case of no deletion, the control returns to step 317. In contrast, when the message to the other terminal tools of the recipient inquired by judgment system 201 of the recipient's end should be deleted, judgment system 101 of the sender's end notifies judgment system 201 of the recipient's end at step 327 that the message sent to the other terminal tools of the recipient should be deleted. At step 328, judgment system 201 of the recipient's end receiving this notification deletes the message sent to the other terminal tools of the recipient determined as the other destinations.

In this embodiment, when there is no terminal tool of the recipient set in the on-state, judgment system 201 of the recipient's end selects, at step 305, one or more terminal tools of the recipient predicted to be earliest set to the on-state at high possibility as candidate for the destination. In this case, after all terminal tools of the recipient are selected as candidate for the destination, a message my be sent to a certain terminal tool of the recipient the moment the certain terminal tool of the recipient is set to the on-state.

Further, when one or more different terminal tools of the recipient is/are set to the on-state earlier than the terminal tools of the recipient predicted at step 305, judgment system 201 of the recipients end inquires of judgment system 101 of the sender's end whether or not judgment system 101 of the sender's end again sends the message to the different terminal tools of the recipient set to the on-state. In this case, without performing the inquiry, the message may be sent to a different terminal tool of the recipient the moment the different terminal tool of the recipient is set to on-state.

Further, when judgment system 101 of the sender's end sends, at step 316, a message in which a part of attached data or the entire attached data is deleted, judgment system 101 may send the deleted part of attached data or the entire attached data to judgment system 201 of the recipient's end after the sending of the message.

Further, after the sending of the message, when judgment system 101 of the sender's end receives an instruction, indicating that judgment system 201 of the recipient's end desires to again receive the attached data formed in a different data format, from judgment system 201 of the recipient's end, judgment system 101 of the sender's end may convert the attached data to attached data having the different data format instructed by judgment system 201 of the recipient's end and send the attached data to judgment system 201.

Further, after the sending of the message, when judgment system 101 of the sender's end receives an instruction, indicating that judgment system 201 of the recipient's end desires to again receive the message at a different terminal tool of the recipient, from judgment system 201 of the recipient's end, judgment system 101 of the sender's end may again send the message to the instructed different terminal tool of the recipient through judgment system 201 of the recipient's end.

Further, after the sending of the message, when judgment system 101 of the sender's end receives a notice indicating that the message having garbled characters was actually received or the communication was undesirably interrupted during the sending of the message, from judgment system 201 of the recipients end, judgment system 101 of the sender's end may again connect with judgment system 201 of the recipient's end and again send the message to judgment system 201.

Further, when no opening of a mail message sent to the terminal tool (e-mail tool) of the recipient is continued for a predetermined period of time, judgment system 201 of the recipient's end may delete the mail message.

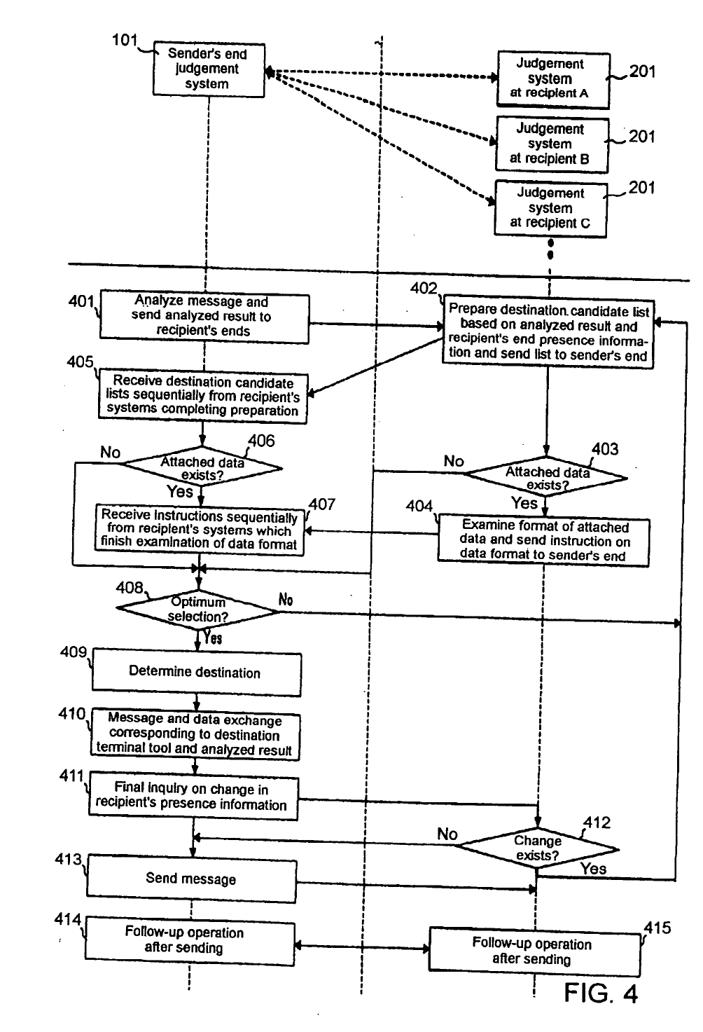

The operation is described above with reference to FIGS. 2 and 3 on condition that the sender and the recipient communicate with each other in one-to-one correspondence. In the present invention, even though the number of users participating in the message sending and reception is increased, for example, to set the sender (or senders) and the recipient (or recipients) to one-to-N (N is an integer higher than unity) correspondence, N-to-1 correspondence or M-to-N correspondence, the processing is basically performed in the same procedure as that shown in FIGS. 2, 3A and 3B. Hereinafter, an operation in the system shown in FIG. 1 will be briefly described with reference to FIG. 4 on condition that one sender and a plurality of recipients communicate with each other in one-to-N correspondence.

Initially, at step 401, judgment system 101 of the sender's end analyzes contents of a message prepared by the sender in one of the sender terminals 11 to 13 and sends an analyzed result of the message to each of a plurality of judgment systems 201 of the recipients. In this case, when attached data is attached to the message, an analyzed result of the attached data is included in the analyzed result of the message.

At step 402, each judgment system 201 of recipient's end prepares a list of one or more candidates for a destination according to the analyzed result of the message sent from judgment system 101 of the sender's end and the recipient's end presence information stored in the presence information DB 202, and sends the prepared destination candidate list to judgment system 101 of the sender's end. In this case, at step 402, in the same manner as at step 252 of FIG. 2, the process of selecting the candidate for the destination and the process corresponding to the existence or non-existence of one or more terminal tools of the recipient already set in an on-state may be performed in each judgment system 201 of recipient's end by considering the convenience of both the recipient and the sender or giving priority to the convenience of either the sender or the recipient. Thereafter, at step 403, each judgment system 201 of recipient's end judges whether or not attached data is attached to the message. When no attached data is attached, the procedure proceeds to the process of step 408. When attached data is attached, each judgment system 201 of recipient's end examines, at step 404, a data format (or form) of the attached data in the sending of the attached data according to information of a storage capacity of each candidate for the destination and the like and instructs the data format of the attached data to judgment system 101 of the sender's end. As to selection items of the data format, for example, there are an original structure of the attached data in the sending, a compressed structure of the attached data in the sending, a divided structure of the attached data in the sending, a partly-deleted structure of the attached data in the sending, an entirely-deleted structure of the attached data in the sending and the like.

At step 405, Judgment system 101 of the sender's end receives the plurality of destination candidate lists sent one after another from judgment systems 201 of the recipient's end each of which completes the examination of the candidate for the destination. At step 406, judgment system 101 of the sender's end judges for each recipient whether or not attached data is attached to the message. When no attached data is attached, the procedure proceeds to the process of step 408. When attached data is attached to the message, judgment system 101 of the sender's end receives, at step 407, Instructions of data formats of the pieces of attached data sent one after another from judgment systems 201 of the recipient's end each of which completes the examination of the data format of the attached data. Thereafter, the procedure proceeds to the process of step 408.

When judgment system 101 of the sender's end receives a destination candidate list from judgment system 201 of one recipient's end desiring to preferentially receive a message, judgment system 101 of the sender's end performs preferentially the process based on the destination candidate list prior to all other processes while stopping the other processes for the other judgment systems 201 of the other recipient's ends. In this case, at step 408, according to the destination candidate list sent from judgment system 201 of the recipient's end desiring to preferentially receive a message and the sender's end presence information stored in presence information DB 102, judgment system 101 of the sender's end judges whether or not an optimum destination exists in the destination candidate list When no optimum destination exists or when judgment system 101 is not satisfied with the candidate for the destination, the procedure proceeds to the process of step 402. When an optimum destination exists, judgment system 101 determines, at step 409, one or more terminal tools of the recipient selected from the destination candidate list as one or more destinations. At steps 408 and 409, In the same manner as at steps 258 and 259 of FIG. 2, the process of determining the destination and the process corresponding to the existence or non-existence of the terminal tools of the recipient of the on-state may be performed by considering the convenience of both the recipient and the sender or giving priority to the convenience of either the sender or the recipient. Further, a communication route is automatically determined to either portable telephone network 30 or Internet 40 according to the destination determined at step 409.

When judgment system 101 of the sender's end determines the destinations at step 409 for each recipient, judgment system 101 determines, at step 410, a form of the message for each recipient so as to correspond to the analyzed result of the message analyzed at step 401 and the terminal tools of the recipient determined at step 409 as the destinations and converts the message to a message having the determined form. Further, when attached data is attached to the message, judgment system 101 converts the attached data to attached data having the data format instructed by judgment system 201 of the recipient's end.

Then, at step 411, judgment system 101 of the sender's end performs a final check of the destinations by inquiring of each judgment system 201 of recipient's end whether or not the recipients end presence information is changed. In response to the final inquiry, each judgment system 201 of recipient's end judges at step 412 for each judgment system 201 whether or not the presence information is changed. When the presence information is changed, the procedure in judgment system 201 of the recipient's end returns to the process of step 402. In contrast, when the recipient's end presence information is not changed at step 412, judgment system 101 of the sender's end sends, at step 413, a message to the tools of one or more corresponding recipient terminals 21, 22 and/or 23 through judgment system 201 of the recipient's end.

After the sending and reception of the message, judgment system 101 of the sender's end and judgment system 201 of each recipient perform follow-up operations based on the result of the message sending and reception at steps 414 and 415 by communicating predetermined information to each other.

In the above description, when judgment system 101 of the sender's end receives, at step 408, a destination candidate list from judgment system 201 of one recipient's end desiring to preferentially receive a message, judgment system 101 of the sender's end judges whether or not an optimum destination exists in the destination candidate list. However, when judgment system 101 of the sender's end receives a plurality of destination candidate lists from judgment systems 201 of all recipients, judgment system 101 of the sender's end may judge whether or not an optimum destination exists in the destination candidate lists. In this case, at step 408, when no destination place exists in the destination candidate lists or when judgment system 101 of the sender's end is not satisfied with the candidate for the destination, the procedure returns to the process of step 402. When an optimum destination exists, judgment system 101 of the sender's end determines, at step 409, one or more terminal tools of one or more recipients as one or more destinations.

Further, after the sending of a mail message to judgment systems 201 of a plurality of recipients, when a predetermined number of recipients open the mail message, judgment system 101 of the sender's end may simultaneously delete the mail messages not yet opened in judgment systems 201 of all other recipients.

The message sending and reception optimizing system can be used for various other examples in dependent from check items to be checked in judgment system 101 of the sender's end and judgment system 201 of recipient's end.

A list of examples of check items to be checked in judgment system 101 of the sender's end and judgment system 201 of each recipient's end is shown in Table 5. A list of examples usable by checking the check items of Table 5 is shown in Table 6. The numbers of the check items in Table 6 correspond to the numbers of the check items in Table 5.

TABLE 5

| No. | Check item | No. | Check item |
|---|---|---|---|
| Check of message contents | | Check of message contents | |
| important in sender | | important in recipient | |
| 1 | Urgency of message | 1 | Urgency of message |
| 2 | Business message or private | 2 | Business message or private message |
| | message | | |
| 3 | Temporal restriction | 3 | Temporal restriction |
| 4 | Positional restriction | 4 | Positional restriction |
| 5 | Restriction of number of users | 5 | Restriction of number of recipients |
| 6 | Subject-matter of message | 6 | Garbled character |
| 8 | Lengthy sentence | 8 | Interesting fields |
| 10 | Mixture of topics | 11 | Business field |
| | | 12 | Message held in common (family, |
| | | | sections, friends) |
| Check relating to | | Check relating to | |
| terminal tool of sender | | terminal tool of recipient | |
| | | 13 | Restriction of data reference for each |
| | | | terminal tool |
| 14 | Electric power consumed in | 15 | Electric power consumed in message |
| | message sending | | reception |
| | | 16 | Size of display panel of terminal |
| | | 17 | Usable storage capacity of terminal |
| 18 | Version of tool | 18 | Version of tool |
| | | 19 | Damage to human body due to reception |
| | | 20 | Lengthy sentence (restriction) |
| Check relating to communication | | Check relating to communication route of | |
| route of sender | | recipient | |
| 21 | Transmission rate | 21 | Transmission rate |
| 22 | Traffic | 22 | Traffic |
| 23 | Cost in communication | 23 | Cost in communication |
| Check relating to conditions of | | Check relating | |
| sender | | to conditions of recipient | |
| | | 24 | With who recipient stays [Judgment based |
| | | | on GPS information and schedule |
| | | | information] |
| | | 25 | Conditions of recipient (toilet, under work, |
| | | | sleeping and the like) [Judgment based on |
| | | | GPS information, schedule information |
| | | | and tendency of use of terminal tool |
| | | | in past time] |
| | | 26 | Distance with terminal of recipient |
| | | | [Judgment based on GPS information] |
| 27 | Relationship between sender and | 27 | Relationship between sender and recipient |
| | recipient (family, lovers, boss, | | (family, lovers, boss, friends and the like) |
| | friends and the like) [Judgment | | [Judgment based on collation in address |
| | based on collation in address | | note and words in message] |
| | note and words in message] | | |
| | | 28 | Work time and rest time |
| | | | Terminal tool predicted to be earliest set to |
| | | | “on” at high possibility [Judgment based |
| | | | on tendency of use of terminal tool in past |
| | | | time and schedule information] |

TABLE 6

| | | No. of |
|---|---|---|
| | | check |
| | Contents of use | item |
| Example 1 | Consideration for business message in private time. | 1, 2, 24, 25 |
| Example 2 | Reception of attached data, to which user of terminal | 7, 13, 16, |
| | cannot refer, is prevented. | 17, 18, 20 |
| Example 3 | Sending and reception are performed so as to reduce | 15, 21 ,22, |
| | communication cost as low as possible. | 23 |
| Example 4 | Attached data is received in terminal in which | 21, 22, 23 |
| | communication rate is low. | |
| Example 5 | Reception of attached data is refused when usable | 17 |
| | storage capacity is low. | |
| Example 6 | Abridged edition of message is automatically prepared | 6, 8, 10, 20 |
| | and sent to portable telephone (main body of message is | |
| | sent to personal computer). | |
| Example 7 | Receipt of message is allowed only when only owner of | 25, 26, 27 |
| | telephone can answer telephone. | |
| Example 8 | Rules are automatically divided for each recipient. | 27 |
| | Automatic denial of message. | |
| Example 9 | When topics of message are mixed with each other | 6, 8, 10, 20 |
| | because of lengthy message, message is divided and | |
| | sent. | |
| Example 10 | Recipients interesting to contents of message are | 6, 9 |
| | automatically detected, and message is simultaneously | |
| | sent to those recipients. | |
| Example 11 | Private message is received at rest time. | 2, 28 |
| Example 12 | Automatic receipt of message to portable telephone is | 19, 24 |
| | refused when user stays with baby. | |
| Example 13 | Business message is received only when user works in | 2, 4, 25 |
| | his or her house. | |
| Example 14 | When message of notice of meeting is sent, messages not | 2, 3 |
| | opened are simultaneously deleted after completion of | |
| | meeting. | |
| Example 15 | When message of notice of party is sent, messages not | 2, 3, 5 |
| | opened are simultaneously deleted when participation of | |
| | predetermined number of persons is determined. | |
| Example 16 | Message of reminder mail indicating merchandise to be | 2, 3, 4, 25 |
| | purchased is sent to recipient who visits predetermined | |
| | area until predetermined time. | |
| Example 17 | Message of reminder mail indicating merchandise to be | 2, 3, 4, 5, 25 |
| | purchased at store is sent to family who passes by store, | |
| | and messages sent to other families and not opened are | |
| | simultaneously deleted after purchase of merchandise. | |

As a concrete process for enabling the use indicated by the Example 1 in Table 6, judgment system 101 of the senders end and judgment system 201 of the recipient's end perform the process (refer to Table 4) described above. However, when the Example 9 among the use Examples 2 to 17 is, for example, enabled, a following process is performed.

Judgment system 101 of the sender's end judges whether or not sentences of a message are too long for a recipient according to the check item #8. In this case, as to restriction of the number of letters/characters in the terminal tools of the recipient, judgment system 101 of the sender's end inquires of judgment system 201 of the recipient's end and judges according to the check item #20.

When judgment system 101 of the sender's end judges that the message is too long, judgment system 101 judges whether or not a plurality of topics mix with one another in the message according to the check item #10, and judgment system 101 judges a subject matter of the message.

Thereafter, judgment system 101 performs a message change in which the message is divided into a plurality of portions having topics respectively and sends the message.

In this invention, the processes in sender's end server 10 and recipient's end server 20 are realized by dedicated hardware described above. However, following architecture may be used. That is, a program for realizing the processes is recorded in a recording medium readable by a computer composed of sender's end server 10 and recipient's end server 20, and the program recorded in the recording medium is read out by sender's end server 10 and recipient's end server 20 and is executed. That is, each of the servers 10 and 20 is realized by a computer such as a computer for server, a personal computer or the like. As to readable recording mediums In sender's end server 10 and recipient's end server 20, hard disk apparatuses arranged in senders end server 10 and recipient's end server 20 can be used as well as a removable recording medium such as a flexible magnetic disk, a magneto-optic disk, CD-ROM or the like. Further, the program may be downloaded to sender's end server 10 and recipient's end server 20 through a network.

While preferred embodiments of the present invention have been described using specific terms, such description is for illustrative purposes only, and it is to be understood that changes and variations may be made without departing from the spirit or scope of the following claims.

1. A method for optimizing sending and reception of a message between a sender's end information processing apparatus disposed on a sender's end of the message and a recipient's end information processing apparatus disposed on a recipient's end of the message, the method comprising the step of:
determining an optimum transmission form of message while considering convenience of a sender and/or a recipient by communicating predetermined information between the sender's end information processing apparatus and the recipient's end information processing apparatus before performance of sending and reception of the message.

2. The method according to claim 1, wherein the step of determining the optimum transmission form comprises the steps of:
analyzing contents of the message in the sender's end information processing apparatus before sending the message; and
sending an analyzed result of the message to the recipient's end information processing apparatus before sending the message.

3. The method according to claim 2, wherein the step of determining the optimum transmission form comprises the steps of:
managing, in the recipient's end information processing apparatus, a recipient's end presence information relating to a condition of the recipient, one or more recipient terminals used by the recipient, one or more messaging tools of each recipient terminal and a communication route of each recipient terminal;
selecting, in the recipient's end information processing apparatus, a candidate for a destination of the message among each messaging tool of each recipient terminal according to the analyzed result sent from the sender's end information processing apparatus and the recipients end presence information managed by the recipient's end information processing apparatus; and
sending a list of the selected candidate for the destination from the recipient's end information processing apparatus to the sender's end information processing apparatus.

4. The method according to claim 3, wherein the step of selecting the candidate comprises the step of selecting the candidate for the destination of the message from one or more messaging tools already set in an on-state when the messaging tools already set in the on-state exist in the messaging tools of the recipient terminals.

5. The method according to claim 3, wherein the step of selecting the candidate comprises the steps of:
predicting one or more messaging tools to be earliest set to an on-state at high possibility when no messaging tool already set in the on-state exists in the messaging tools of the recipient terminals; and
selecting the predicted messaging tool as the candidate for the destination.

6. The method according to claim 3, wherein the step of selecting the candidate for the destination comprises the step of selecting the candidate for the destination by considering convenience of both the recipient and the sender or by giving priority to convenience of the recipient or the sender.

7. The method according to claim 3, wherein the step of determining the optimum transmission form further comprises the steps of:
managing, in the sender's end information processing apparatus, sender's end presence information relating to a condition of the sender, one or more sender terminals, one or more messaging tools of each sender terminal and a communication route of each sender terminal; and
determining, in the sender's end information processing apparatus, one or more optimums destinations from the list of the candidate for the destination sent from the recipient's end information processing apparatus, according to the list of the candidate for the destination and the sender's end presence information managed in the sender's end information processing apparatus.

8. The method according to claim 7, wherein the step of selecting the candidate for the destination comprises the step of determining the optimum destination by considering convenience of both the recipient and the sender or by giving priority to convenience of the recipient or the sender.

9. The method according to claim 7, further comprising the step of determining, in the sender's end information processing apparatus, a communication route according to the optimum destination determined from the candidate for destination.

10. The method according to claim 9, further comprising the step of determining, in the sender's end information processing apparatus, a form of the message so as to correspond to the analyzed result and the optimum destination determined from the list of the candidate for the destination.

11. The method according to claim 10, further comprising the step of converting the message into that of the determined form and then sending the message from the sender's end Information processing apparatus to the determined optimum destination through the determined communication route.

12. The method according to claim 11, wherein the step of sending the message to the determined optimum destination comprises the steps of:
inquiring of the recipient's end information processing apparatus whether or not the recipient's end presence information is changed; and
sending the message only when the recipient's end presence information is not changed.

13. The method according to claim 11, further comprising the steps of:
analyzing, in the sender's end information processing apparatus, contents of attached data in addition to the message when the attached data is attached to the message;
sending an analyzed result of the attached data with the analyzed result of the message to the recipient's end information processing apparatus;
sending an instruction to the sender's end information processing apparatus in the recipient's end information processing apparatus according to the analyzed result of the attached data, said instruction indicating a data form of the attached data in the sending of the attached data, the analyzed result of the attached data being sent from the sender's end Information processing apparatus; and
sending the attached data from the sender's end information processing apparatus to the determined optimum destination through the determined communication routes with the message after converting the attached data to that of the data form indicated by the instruction from the recipient's end information processing apparatus.

14. The method according to claim 1, further comprising the step of:
performing a follow-up operation based on a result of the message sending and reception by communicating predetermined information between the sender's end information processing apparatus and the recipient's end information processing apparatus after performing the message sending and reception.

15. A system for optimizing sending and reception of a message, said system comprising:
a sender's end information processing apparatus disposed on a sender's end of a message; and
a recipient's end information processing apparatus disposed on a recipient's end of the message and connected with the sender's end information processing apparatus through a network,
wherein the sender's end information processing apparatus comprises a sender's end judgment system, the recipient's end information processing apparatus comprises a recipient's end judgment system, and the sender's end judgment system and the recipient's end judgment system determine, before performing message sending and reception, an optimum transmission form of the message while considering convenience of a sender and/or a recipient by communicating predetermined information with each other.

16. The system according to claim 15, wherein, before the sender's end information processing apparatus sends the message, the sender's end judgment system analyzes contents of the message in the sender's end information processing apparatus and sends an analyzed result of the message to the recipient's end judgment system.

17. The system according to claim 16, wherein the recipient's end information processing apparatus further comprises recipient's end presence information storing means for storing recipient's end presence information relating to a condition of the recipient, one or more recipient terminals used by the recipient, one or more messaging tools of each recipient terminal and a communication route of each recipient terminal, and
the recipient's end judgment system selects one or more candidates for a destination of the message among the messaging tools of the recipient terminals according to the analyzed result sent from the sender's end judgment system and the recipient's end presence information stored in the recipients end presence information storing means and sends a list of the selected candidate for the destination to the sender's end judgment system.

18. The system according to claim 17, wherein, in selection of the candidate for the destination, the recipients end judgment system selects the candidate for the destination from one or more messaging tools already set in an on-state when the messaging tools already set in the on-state exist in the messaging tools of the recipient terminals.

19. The system according to claim 17, wherein, in selection of the candidates for the destination, the recipient's end judgment system predicts one or more messaging tools to be earliest set to an on-state at high possibility when no messaging tool already set In the on-state exists in the messaging tools of the recipient terminals and selects the predicted messaging tool as the candidate for the destination.

20. The system according to claim 17, wherein, when the candidate for the destination is selected, the recipient's end judgment system selects the candidate for the destination by considering convenience of both the recipient and the sender or selects the candidates for the destination by giving priority to the recipient or the sender.

21. The system according to claim 17, wherein the sender's end information processing apparatus further comprises sender's end presence information storing means for storing senders end presence information relating to a condition of the sender, one or more sender terminals used by the sender, one or more messaging tools of each sender terminal and a communication route of each sender terminal, and
the sender's end judgment system determines one or more optimum destinations from the list of the candidates for destination sent from the recipient's end judgment system, according to the list of the candidate for the destination and the sender's end presence information stored in the sender's end presence information storing means.

22. The system according to claim 21, wherein, when the optimum destination is determined, the senders end judgment system determines the optimum destination by considering convenience of both the recipient and the sender or determines the optimum destination by giving priority to the recipient or the sender.

23. The system according to claim 21, wherein the sender's end judgment system determines one or more communication routes according to the optimum destination determined from the candidate for the destination.

24. The system according to claim 23, wherein the sender's end judgment system determines a form of the message so as to correspond to the analyzed result of the message and the optimum destination determined from the list of the candidate for the destination.

25. The system according to claim 24, wherein the sender's end judgment system converts the message into that of the determined form and then sends the message to the determined optimum destination through the determined communication route.

26. The system according to claim 25, wherein, when the message is sent, the sender's end judgment system inquires of the recipient's end judgment system whether or not the recipient's end presence information is changed and sends the message only when the recipient's end presence information is not changed.

27. The system according to claim 25, wherein
when attached data is attached to the message, the sender's end judgment system analyzes contents of the attached data in addition to the message and sends an analyzed result of the attached data to the recipient's end judgment system with the analyzed result of the message,
the recipient's end judgment system sends an instruction to the sender's end judgment system according to the analyzed result of the attached data, said instruction indicating a data form of the attached data in sending of the attached data, the analyzed result of the attached data being sent from the sender's end judgment system, and
the sender's end judgment system converts the attached data into the data form indicated by the instruction from the recipient's end judgment system and sends the attached data to the determined optimum destination through the determined communication route with the message.

28. The system according to claim 15, wherein the sender's end judging system and the recipient's end judging system perform a follow-up operation based on a result of the message sending and reception by communicating predetermined Information between the sender's end judging system and the recipient's end judging system after performing the message sending and reception.

29. An information processing apparatus disposed on a sender's end of a message, the information processing apparatus comprising:
a judgment system for determining an optimum transmission form of message, before performing the message sending and reception, while considering convenience of a sender and/or a recipient by communicating predetermined Information with a recipient's end information processing apparatus disposed on a recipient's end of the message.

30. The information processing apparatus according to claim 29, wherein, before sending the message, the judgment system analyzes contents of the message, sends an analyzed result to the recipient's end information processing apparatus and requires the recipient's end information processing apparatus to select one or more candidates for a destination of message from one or more messaging tools of one or more recipient terminals used by the recipient according to the analyzed result.

31. The information processing apparatus according to claim 30, further comprising:
presence information storing means for storing sender's end presence information relating to a condition of the sender, one or more sender terminals used by the sender, one or more messaging tools of each sender terminal and a communication route of each sender terminal,
wherein, when a list of the candidate for the destination is sent from the recipient's end information processing apparatus to the judgment system, the judgment system determines one or more optimum destinations selected from the list of the candidate for the destination, according to the list of the candidate for the destination and the sender's end presence information stored in the presence information storing means.

32. The information processing apparatus according to claim 31, wherein, when the judgment system determines the optimum destination, the judgment system determines the optimum destination by considering convenience of both the recipient and the sender or determines the optimum destination by giving priority to the recipient or the sender.

33. The information processing apparatus according to claim 31, wherein the judgment system determines one or more communication routes according to the optimum destination determined from the candidate for the destination.

34. The information processing apparatus according to claim 33, wherein the judgment system determines a form of the message so as to correspond to the analyzed result and the optimum destination determined from the list of the candidate for the destination.

35. The information processing apparatus according to claim 34, wherein the judgment system converts the message into that of the determined form and then sends the message to the determined optimum destination through the determined communication route.

36. The information processing apparatus according to claim 35, wherein, when attached data is attached to the message, the judgment system analyzes contents of the attached data in addition to the message, sends an analyzed result of the attached data to the recipient's end information processing apparatus with the analyzed result of the message and requests the recipients end information processing apparatus to send an instruction indicating a data form of the attached data in sending of the attached data according to the analyzed result of the attached data, and the Judgment system converts the attached data into that of the instructed data form, when the judgment system receives the instruction from the recipient's end information processing apparatus, and sends the attached data to the determined optimum destination through the determined communication route with the message.

37. The information processing apparatus according to claim 29, wherein, after performing the message sending and reception, the judgment system performs a follow-up operation based on a result of the message sending and recption by communicating predetermined information with the recipient's end information processing apparatus.

38. An information processing apparatus disposed on a recipient's end of a message, the information processing apparatus comprising:
a judgment system for determining an optimum transmission form of message, before performing the message sending and reception, while considering convenience of a sender and/or a recipient by communicating predetermined information with a senders end information processing apparatus disposed on a sender's end of the message.

39. The information processing apparatus according to claim 38, further comprising:
presence information storing means for storing recipient's end presence information relating to a condition of the recipient, one or more recipient terminals used by the recipient, one or more messaging tools of each recipient terminal and a communication route of each recipient terminal,
wherein, when an analyzed result of the message is sent from the sender's end information processing apparatus to the judgment system, the judgment system selects one or more candidates for a destination of message among the messaging tools of the recipient terminals according to the sent analyzed result and the recipient's end presence Information stored in the presence information storing means, sends a list of the selected candidate for the destination to the sender's end information processing apparatus and requests the sender's end information processing apparatus to determine one or more optimum destination from the list of the selected candidate for the destination.

40. The information processing apparatus according to claim 39, wherein, in selection of the candidate for the destination, the judging system selects the candidate for the destination from one or more messaging tools already set in an on-state when the messaging tools already set in the on-state exist in the messaging tools of the recipient terminals.

41. The information processing apparatus according to claim 39, wherein, in selection of the candidate for the designation, the judging system predicts one or more messaging tools to be earliest set to an on-state at high possibility when no messaging tool already set in the on-state exists in the messaging tools of the recipient terminals and selects the predicted messaging tool as the candidate for the destination.

42. The information processing apparatus according to claim 39, wherein, in selection of the candidate for the designation, the judging system selects the candidate for the designation by considering convenience of both the recipient and the sender or selects the candidate for the designation place by giving priority to either the recipient or the sender.

43. The Information processing apparatus according to claim 36, wherein, when the analyzed result of the attached data attached to the message is sent from the sender's end information processing apparatus to the judgment system, the judgment system notifies the sender's end information processing apparatus of a data form in sending of the attached data.

44. The information processing apparatus according to claim 38, wherein, after performing the message sending and reception, the judgment system performs a follow-up operation based on a result of the message sending and reception by communicating predetermined information with the sender's end information processing apparatus.
